(19) United States
(12) Patent Application Publication
(10) Pub. No.: US 2024/0077094 A1
(43) Pub. Date: Mar. 7, 2024

(54) Bead Product System

(71) Applicant: Karen Woojung Han Liao, Tustin, CA (US)

(72) Inventor: Karen Woojung Han Liao, Tustin, CA (US)

(21) Appl. No.: 18/357,118

(22) Filed: Jul. 22, 2023

Related U.S. Application Data
(60) Provisional application No. 63/402,954, filed on Sep. 1, 2022.

(51) Int. Cl. F16B 2/22

(52) U.S. Cl. CPC F16B 2/22; A44C 27/001

(57) ABSTRACT

A bead product is provided. The bead product comprises a plurality of beads, each of the plurality of beads having a first surface facing a first direction opposing a second surface facing a second direction; a plurality of holding members, one of the plurality of holding members disposed within or attached to the plurality of beads; a framework formed from the holding member and the plurality of beads, the framework having a first configuration and a second configuration; and a locking mechanism, the locking mechanism locks positions of the holding member, the plurality of beads or both on the framework in the first configuration and the locking mechanism unlocks only a predetermined bead of the plurality beads for movement on the framework in the second configuration. Systems and methods are disclosed.

### TECHNICAL FIELD

The present disclosure generally relates to using a set of ornamental members for setting different bead designs, and more particularly for an accessory with a locking mechanism using the same ornamental members to exhibit various different decorative appearances or functional appearances such as a word, a sign, a symbol including an emoji.

### BACKGROUND

As known, a goldsmith, jewel designer or a profession working with jewelry and/or similar jewels often include the use of beads. Beads are generally defined as small pieces of glass, stone, plastic or other materials, typically rounded and sometimes, perforated for threading with other beads, to form designs. A known process that utilizes the beads is a beading process. In the beading process, the beads are strung together by a thread to create a multitude of products. Many beading products are weaved, that is formed by interlacing long threads pass in one direction with others at a right angle to them, either on a loom or free hand. The resultant products are used for, and as, but not limited to, necklaces, earrings, bracelets, belts, headbands, decorative appliques, purses, and etcetera. These beaded products are of varying widths and lengths.

The conventional use of the beads is thus limited in such strung manner. Some techniques are used to further organize the strung beads into a predetermined size and shaped which are substantially self-enclosed. However, these techniques are still limited by the conventional method of beading process and the organization is limited by the voided structures created by the gaps among the beads as disclosed in U.S. Pat. No. 8,097,336. Engineers or construction personnel typically search for material or a product that have sustainable construct to form a layer for holding material or a user. When such organized structures are formed, the design function of beads are ignored and lost. The beads on the organized structures become mere place holders that are replaceable by other materials. Thus, the conventional organized structure allows the beads to freely move translationally and rotate axially; or the beads are set in limited pattern that has only few predetermined movements. The beads lack a mechanism to be controlled by a user.

The use of the beads is thus polarized and divided by the ornamental professionals or engineers. As both sides are only focusing on their perspective uses of beads, there lack attempt to solve the problem of the free moving beads in an organized structure. Accordingly, there exists a need for a bead product system that allows a user to control the movement of the beads and beading patterns on an organized structure. This disclosure describes an improvement over these prior technologies.

### SUMMARY

In one embodiment, a bead product system is provided. The bead product system comprises a plurality of beads, each of the plurality of beads comprising a configuration, the configuration having a first range of axial positions in a first configuration, having a second range of axial positions in a second configuration and having a third range of axial positions in a third configuration; a plurality of holding members partially disposed within the plurality of beads having a pivot allowing each of the plurality of beads to rotate; and a locking mechanism configured to lock the plurality of the plurality of beads in the first range of axial positions and to unlock only a first bead of the plurality of beads allowing the first bead to rotate to the second range of axial positions, and the locking mechanism also configured to lock the plurality of the plurality of beads in the second range of axial positions, the locking mechanism comprising a second bead of the plurality of beads adjacent to the first bead preventing the first bead to rotate from the first configuration to the second configuration.

In some embodiments, a bead product is provided. The bead product comprises a plurality of beads comprising a first bead having a first axial position and a second bead having an edge adjacent to the first bead; a link disposed within the plurality of beads connecting the plurality of beads, the link comprising an arm and an elbow such that the first bead configured to be rotated on a pivot formed by the elbow; and a locking mechanism formed by the edge of the second bead locking the first bead such that the first bead cannot rotate more than 45 degrees.

In some embodiments, a method of making a bead product system is provided. The method comprises providing a plurality of beads, each of the plurality of beads having a first surface facing a first direction opposing a second surface facing a second direction; providing a plurality of holding members, one of the plurality of holding members disposed within or attached to the plurality of beads; arranging the holding member and the plurality of beads to form a first configuration having a first range of axial positions; and providing a locking mechanism, the locking mechanism setting axial angles for the first range of axial positions of the plurality of holding members, the plurality of beads or both in the first configuration and the locking mechanism being configured to unlock the plurality beads to change axial positions to reach a second range of axial positions.

Additional features and advantages of various embodiments will be set forth in part in the description that follows, and in part will be apparent from the description, or may be learned by practice of various embodiments. The objectives and other advantages of various embodiments will be realized and attained by means of the elements and combinations particularly pointed out in the description and appended claims.

### BRIEF DESCRIPTION OF THE DRAWINGS

The present disclosure will become more readily apparent from the specific description accompanied by the following drawings, in which:

FIG. 1 is a perspective view of one embodiment of a bead product system;

FIG. 2 is a side view of a bead product system shown in FIG. 1;

FIG. 3 is a top view of a bead product system shown in FIG. 1;

FIG. 4 is a front view of a bead product system shown in FIG. 1;

FIG. 5 is a front view of one embodiment of components shown in FIG. 1;

FIG. 6 is a perspective view of one embodiment of components shown in FIG. 1;

FIG. 7 is a perspective view of another embodiment of components shown in FIG. 1;

FIG. 8 is a front view of another embodiment of components shown in FIG. 1;

FIG. 9 is a front view of another embodiment of components shown in FIG. 1;

FIG. 10 is a front view of one embodiment of a bead product system; and

FIG. 11 is a front view of one embodiment of a bead product system.

### DETAILED DESCRIPTION

The exemplary embodiments of the bead product system and related methods of use disclosed are discussed in terms of jewelry and ornament decorations. It is to be understood that the disclosed embodiments and the combination of different embodiments are merely exemplary that may be embodied in various and alternative forms. The figures are not necessarily to scale; some features may be exaggerated or minimized to show details of particular components. Therefore, specific structural and functional details disclosed herein are not to be interpreted as limiting, but merely as a basis for the claims and as a representative basis for teaching one skilled in the art to variously employ the present disclosure.

The bead product system of the present disclosure may be understood more readily by reference to the following detailed description of the embodiments taken in connection with the accompanying drawing figures, which form a part of this disclosure. It is to be understood that this application is not limited to the specific devices, methods, conditions or parameters described and/or shown herein, and that the terminology used herein is for the purpose of describing particular embodiments by way of example only and is not intended to be limiting. In some embodiments, as used in the specification and including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment. It is also understood that all spatial references, for example, horizontal, vertical, top, upper, lower, bottom, left and right, are for illustrative purposes only and can be varied within the scope of the disclosure. For example, the references “upper” and “lower” are relative and used only in the context to the other, and are not necessarily “superior” and “inferior”.

The following discussion includes a description of a bead product system including a plurality of beads and a plurality of holding members, related components and methods of employing the bead product system in accordance with the principles of the present disclosure. Alternate embodiments are also disclosed. Reference is made in detail to the exemplary embodiments of the present disclosure, which are illustrated in the accompanying figures.

The components of bead product system 100 can be fabricated from various materials suitable from a view only decorated art piece to a coaster or a sitting pad, including metals, woods, bamboo, polymers including plastics, ceramics and and/or their composites. Various components of bead product system 100 may have material composites, including the above materials, to achieve various desired characteristics such as strength, rigidity, elasticity, compliance, durability and child-safety. The components of bead product system 100, individually or collectively, may also be fabricated from a heterogeneous material such as a combination of two or more of the above-described materials. The components of bead product system 100 may be monolithically formed, integrally connected or include fastening elements and/or instruments, as described herein.

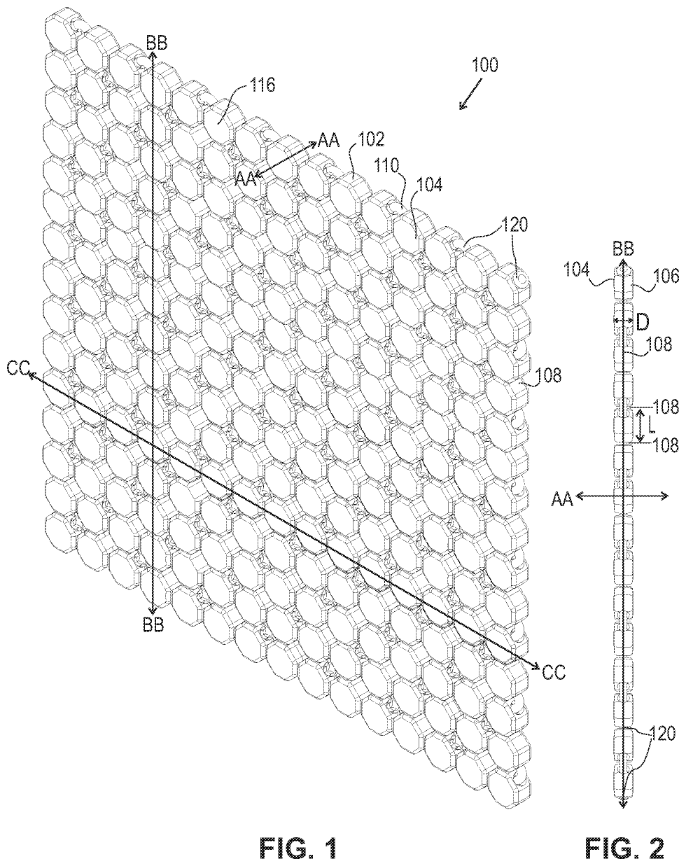

In some embodiments, a bead product system comprising, consisting essentially of, or consisting of the following features is provided. Bead product system 100 includes bead 102 and holding member 120, as shown in FIGS. 1-10. Bead 102 has a length, width and depth forming various shapes including circle, semi-circle oval, doughnut, rectangle, square, pentagon, hexagon, octagon, and/or a combination there of. For example, bead can have a semi-circle in upper half and the bottom half having a square. FIG. 1 shows a perspective view of the bead product system, which comprises bead 102. The bead has first surface 104, second surface 106 and side surface 108. The first surface faces a direction opposing the second surface on an axis. In some embodiments, the first surface opposes the second surface on an axis AA across the depth of the bead product system, as shown in FIG. 2. In some embodiments, the first surface opposes the second surface on an axis BB across the length of the bead product system. In some embodiments, the first surface opposes the second surface on an axis CC across the width of the bead product system. The bead also comprises first opening 110 and second opening 112. In some embodiments, some beads only comprise with only one opening. Bead comprises bead body 116 having an internal structure inside the bead body and makes the bead body partially and/or substantially hollow. The side surface disposed between the first surface and the second surface surrounding the perimeter of the bead body. The side surface faces a direction transverse the first surface and the second surface. In some embodiments, when the first surface faces a direction along the axis AA, the side surface may face a direction along the axis BB and/or CC simultaneously.

The holding member is disposed within one or more beads in the bead product system. The holding member goes through the first opening and the second opening of the bead body. In some embodiments, the holding member only goes through one opening of the bead body. In some embodiments, the holding member has an extended length capable of going through more than one bead body. In some embodiments, the holding member only goes through one single bead body. In another embodiment, the holding member does not go through the entire bead body. In some embodiments, the holding member is a thread. The thread goes through a plurality of beads and the beads pivot directly on the thread.

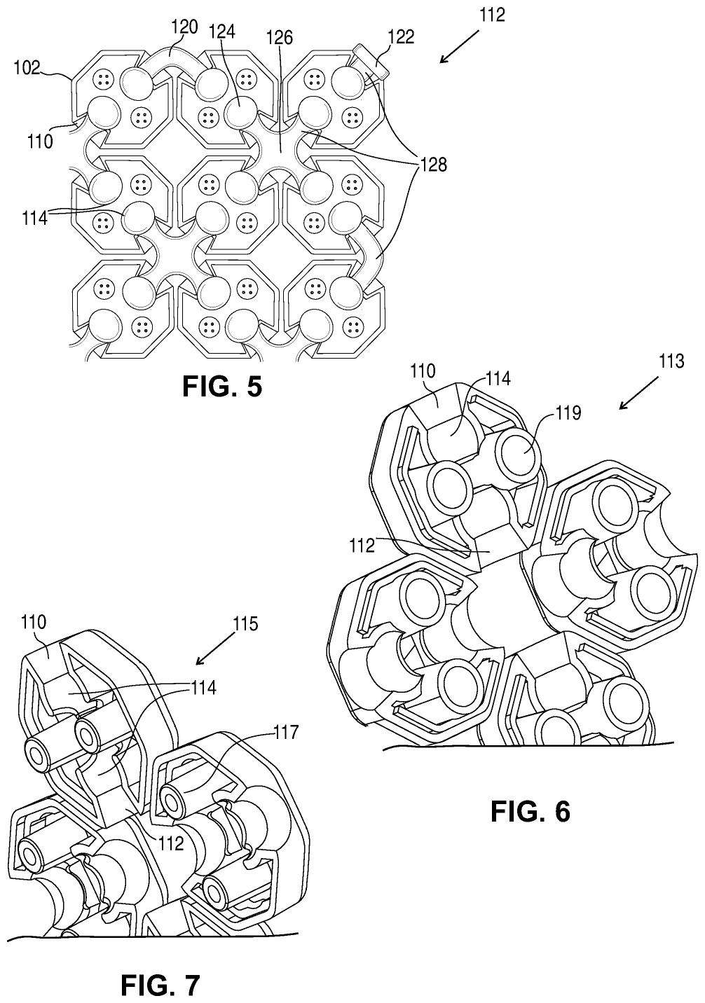

FIG. 2 shows a side view of the bead product system. A depth D across first surface 104 and second surface 106 along an axis AA. A plurality of side surfaces 108 disposed in between first surface and second surface around the perimeter of the bead body. The topmost side surface and the bottommost surface across the bead body along the axis BB define a length L. Holding member 120 is shown to connect between two beads. The holding member also has an end piece 122, as further demonstrated in FIGS. 4 and 5.

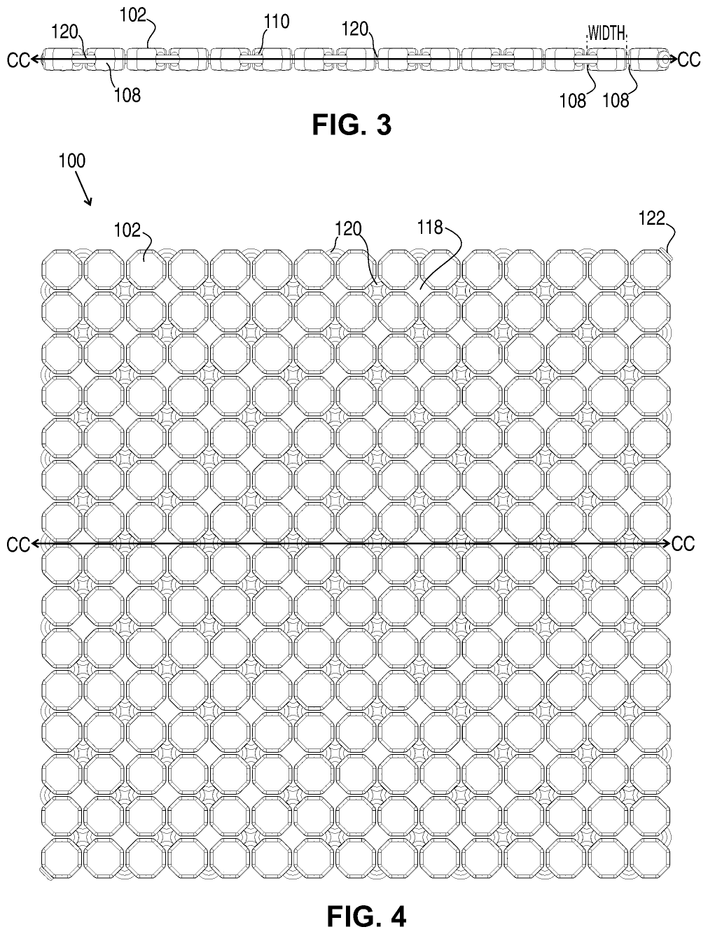

FIG. 3 shows a top view of the bead product system. From the leftmost side surface 108 to the rightmost side surface of the bead body along the axis CC defines a width W of a bead body. The holding member 120 passes through an opening 110 of a bead 102 and into an opening of another bead. In some embodiments, the holding member passes through multiple openings of multiple beads simultaneously.

FIG. 4 shows a front view of the bead product system 100. A plurality of beads 102 is connected through a plurality of the holding members 120. In some embodiments, a plurality of beads is connected through one single holding member. The holding member may connect one or more beads. In some embodiments, the holding member comprises holding member end piece 122 that disposes in only one bead and does not connect to another bead. The bead product system further comprises void 118 among beads. In some embodiments, the void is defined by the gap space among beads. In some embodiments, the void is defined between two beads. In some embodiments, the void is the gap among three beads. In some embodiments, the void is gap among four beads. In some embodiments, the holding member may be disposed on, or passing through the void. In some embodiments, the holding member shows a crescent between openings of beads across the void. In some embodiments, the holding member shows a cross in the void space. In some embodiments, the voids and the holding members are arranged to facilitate structural and locking support for the bead product system to show an ornamental or functional pattern. In some embodiments, the holding member and the void are arranged to alternate across an axis CC.

FIG. 5 depicts components of one embodiment of the bead product system in a dissembled view. The bead 102 comprises first opening 110 and second opening 112 each is configured to receive a holding member 120. The holding member comprises an elbow 124 and a body 126. The elbow and the body are connected by an arm 128. In some embodiment, the holding member comprises an elbow 124 and an end piece 122. An elbow comprises various shapes including circle, semi-circle oval, doughnut, rectangle, square, pentagon, hexagon, octagon, and/or a combination there of. The elbow is configured to be disposed into the opening of the bead and into a recess area 114 in the bead body. The recess area comprises various shapes including circle, semi-circle oval, doughnut, rectangle, square, pentagon, hexagon, octagon, and/or a combination there of. The recess area corresponds to the shape of the elbow. Once the elbow is disposed in a recess area, the shape or the curvature of the recess area contains at least partially of the elbow allowing the elbow to serve as a pivot point for the bead to rotate. The elbow cannot move outside of the recess area. The arm extending out from the elbow passes through the first opening or the second opening extending outside of the beads. The body comprises various shapes including circle, semi-circle oval, doughnut, rectangle, square, pentagon, hexagon, octagon, and/or a combination there of. In some embodiments, the body is tubular. The body is center of mass of a holding member. When the center of the mass is an arm 128 or is a tubular shape, the entire arm is body. In some embodiments, the body serves as a joint of multiple arms 128. The bead can receive one or two holding members. In some embodiments, the bead has two recess areas receiving two elbows, one elbow having an arm extending out from the first opening and the other elbow has another arm extending out from the second opening. In some embodiments, the bead receives only one holding member. In some embodiments, the bead comprises only one opening and receives only one holding member. In some embodiments, the bead comprises only one recess area. In some embodiments, the bead comprises two recess areas configured to receive two separate holding members. In some embodiments, the holding member is configured to be disposed in only one bead. In some embodiment, the holding member is configured to be disposed in a plurality of beads including two, three, four and more beads.

FIG. 6 and FIG. 7 show components of a bead in accordance to one embodiment of the bead product system. In some embodiments, the bead comprises a plurality of pieces. In some embodiments, the bead comprises first piece 113 and second piece 115. Both pieces comprise first opening 110 and second opening 112 and recess area 114. The first piece further comprises cavity 119 and the second piece further comprises protrusion 117 such that protrusion can be received in the cavity and connect the two pieces into one single bead. In some embodiments, the bead is a monolithic body comprising the first opening, the second opening and the recess area. In some embodiments, the first piece comprises an interior structure and an exterior surface. In some embodiments, the exterior surface comprises the first surface and a partial third surface or an edge of the bead. The second piece also comprises an interior structure and an exterior surface. In some embodiments, the exterior surface comprises the second surface and a partial third surface or an edge of the bead. The interior structure of the first piece and the interior structure of the second piece form first opening, the second opening and the recess area. In some embodiments, the interior structure also comprises a securing mechanism securing the first piece and the second piece to form a bead and also secure the holding member inside the bead. In some embodiments, the securing mechanism comprises the cavity and the protrusion. In some embodiments, the securing mechanism comprises a latch, a notch, a pin and a slot, or combination thereof.

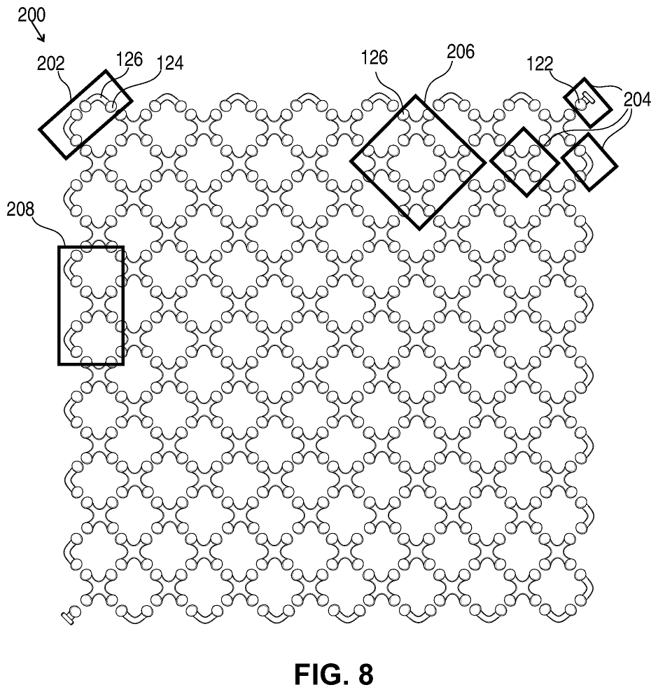

FIG. 8 depicts a front view of framework 200 of the bead product system. The framework forms the internal structure and design of the bead product system. The framework is formed from a single holding member or various combinations of holding members. In some embodiment, one single holding member forms one-piece module 204. In some embodiments, the holding member comprises one body 126 and one elbow 124. In some embodiments, the holding member comprises one body and a plurality of elbows. In some embodiments, elbows are the end points of the body of the holding member. In some embodiments, the holing member comprises one body and two elbows. In some embodiments, the holding member comprises one body and three elbows. In some embodiments, the holding member comprises one body and four elbows. In some embodiments, the holding member comprises one body and five or more elbows. In some embodiments, the holding member comprises an elbow and an end piece 122. In some embodiments, the holding member comprises with only an end piece, only an elbow, or only a body. In some embodiments, two holding members form a two-piece module 202. In some embodiments, three holding members form a three-piece module 208. In some embodiments, four holding members form a four-piece module 206. In some embodiments, five or more holding members are used to form higher sequence module. In some embodiments, the various modules combine to form the framework of the bead product system. As shown in FIG. 8, the framework 200 comprises corners formed from one-piece module 204 and corners formed from two-piece module 202; edges comprise three-piece module; and internal body formed from four-piece module. In some embodiments, the framework is formed from one kind of modules. In some embodiments, the framework is formed from one single module.

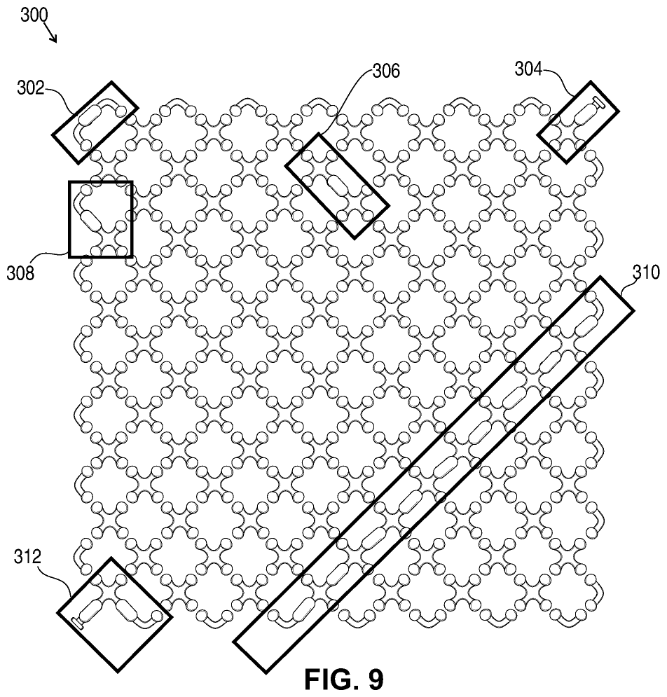

FIG. 9 depicts a front view of another embodiment of framework 300 of the bead product system. The holding member comprises various irregular shapes and elbows are not limited to end points of the body of the holding member. Elbows are disposed at various locations of the body. In some embodiments, the holding member has an n-shape 302, which has two elbows at the tips of the n and one elbow in the middle of the horizontal line part of the n. In some embodiments, the holding member is cross-shaped 304, double t-shaped 306, t-shaped 308. In some embodiments, the holding member extends across a width or a length of the bead product system. In some embodiments, the holding member having a chained-crosses shape 310 extends across a diagonal line of the bead product system. In some embodiments, the holding member has the beads forming a triangular shape 312 with a bead in the corner.

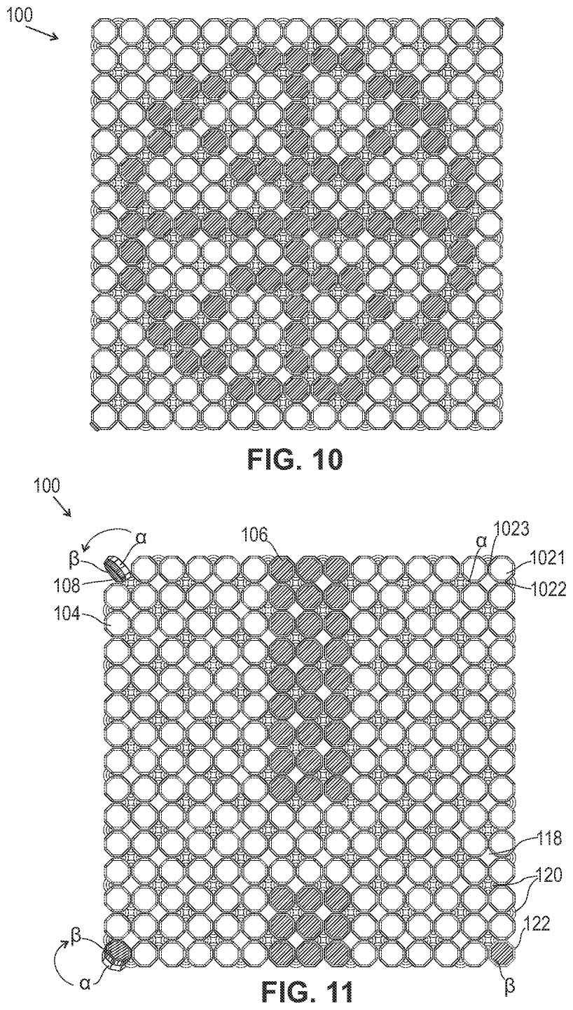

FIG. 10 shows a front view of one embodiments of the bead product system 100. Some beads are shown with their first surface 104 and some beads are shown with their second surface 106 such that the arrangement of the first surface and the second surface forms a particular ornamental pattern. In some embodiments, beads are arranged to show a symbol with the second surface and having the first surface as the background as demonstrated in FIG. 11. An exclamation symbol has been displayed in a front view of one embodiments of the bead product system 100. The first surface 104 shows a first colored background and the second surface 106 shows an exclamation symbol in a second color. Holding members 120 are configured to connect the beads showing the first surface and the second surface. End piece 122 is disposed at a corner of the bead product system. Void 118 are disposed among beads. Four corner beads are rotated axially at 90 degrees such that the first surface and the second surface face transversely to other beads. FIG. 11 also shows a range of angles α and β indicating an axial position and/or radial direction of a bead. α and β complimentary each other to form a full 360 degree circle defining all axial positions of a full rotation. In some embodiments, the first surface and the second surface comprise different texture characteristics such that the arrangement of the first surface and the second surface form a particular texture surface pattern allowing a user to acknowledge different touching sensations. This arrangement facilitates a child user to enhance their ability to learn about their five senses. In one embodiment, the first surface and the second surface are made from different material such that a user to use the bead product as a sitting mat and select desired pattern and feel on the sitting mat. In another embodiment, the first surface and/or the second surface is magnetic such that the bead product system is configured to attach metal articles.

In one embodiment, a bead product system 100 is provided as in FIG. 1. The bead product system includes a plurality of beads 102, each bead has multiple configuration and ranges of axial positions based on its axial angles α and β, the configuration having a first range of axial positions in a first configuration, having a second range of axial positions in a second configuration and having a third range of axial positions in a third configuration; a plurality of holding members 120 partially disposed within the plurality of beads having a pivot such as an elbow 124 shown in FIG. 8 allowing each bead to rotate; and a locking mechanism configured to lock the plurality of the plurality of beads in the first range of axial positions and to unlock only a first bead of the plurality of beads such as bead 1021 shown in FIG. 10 allowing the first bead to rotate to the second range of axial positions, and the locking mechanism also configured to lock the plurality of the plurality of beads in the second range of axial positions, the locking mechanism comprising a second bead of the plurality of beads such as bead 1022 shown in FIG. 10 adjacent to the first bead preventing the first bead to rotate from the first configuration to the second configuration. In some embodiments, the first range of axial positions comprises an axial position at from about 0 to about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59 to about 60 degrees. A maximum angle of the first range of axial position is a first restrictive angle that blocks the bead from rotating into the second range of axial positions. Once bead surpass the first restrictive angle, the bead is in the second range of axial positions. The second range of axial positions comprises an axial position starting from 0 degree from the first restrictive angle to about to about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59 to about 60 degrees or a maximum angle of the second range of axial position, which is the second restrictive angle that blocks the bead from rotating into the third range of axial positions. The third range of axial positions comprises an axial position starting from 0 degree from the second restrictive angle to about to about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59 to about 60 degrees or a maximum angle of the third range of axial position, which is the third restrictive angle that blocks the bead from rotating into the first range of axial positions. Three ranges of axial position forms a full circle of 360 ranges and defines all axial positions of a bead.

In some embodiments, the locking mechanism unlocks only one single bead of the plurality of beads to rotate. In another embodiment, the locking mechanism can unlock multiple beads allowing them to rotate simultaneously. In some embodiments, the plurality of beads in the third configuration is facing opposite direction along an axis from the plurality of beads in the first configuration, as shown in FIG. 10. In some embodiments, the plurality of beads in the second configuration is configured to be transverse to the plurality of beads in the first configuration.

In some embodiments, the second bead comprises a perimeter or an edge form by the side surface 108 contacting and/or blocking the first bead from rotating into the second configuration. In some embodiments, the locking mechanism comprises multiple locking points. The multiple locking points are formed by multiple edges of the beads adjacent to the locked bead. In some embodiments, the locking points are formed by the perimeters of a bead when the bead has a circular edge. In some embodiments, the first bead in the first range of axial positions is locked by a third bead such as bead 1023 shown on FIG. 10 adjacent to the first bead such that the first bead does not rotate into the second configuration. In some embodiments, the locking mechanism having at least two holding members of the plurality of holding members being parallel. In some embodiments, the locking mechanism having at least two holding members of the plurality of holding members being perpendicular. In some embodiments, each of the plurality of holding members comprises a body 126 having an arm and an elbow 124. In some embodiments, the body is a tubular arm 126.

In another embodiment, a bead product is provided as in FIG. 1. The bead product includes a plurality of beads 102 comprising a first bead such as bead 1021 in FIG. 10 having a first axial position and a second bead having an edge adjacent to the first bead; a link such as 120 as in FIG. 8 disposed within the plurality of beads connecting the plurality of beads, the link comprising an arm 126 and an elbow 124 such that the first bead configured to be rotated on a pivot formed by the elbow; and a locking mechanism formed by the edge of the second bead locking the first bead such that the first bead cannot rotate more than 45 degrees.

In some embodiments, the links is flexible such that the link is configured to increase a distance between the first bead and the second bead. In some embodiment the distance is represented by the voids 118 among the beads. In some embodiments, the plurality of beads comprises a third bead such as bead 1023 in FIG. 10 having a second edge and forming the locking mechanism to the second bead. In some embodiments, the perimeter or the edges of the bead are also represented by the side surface 108 of the bead. In some embodiments, the locking mechanism comprises an unlock distance defined by the void. As shown in FIGS. 8 and 10, in some embodiments, the link comprises a first link and a second link, the first link and the second link being parallel such that the plurality of beads on the first link contact and the block the plurality of beads on the second link when the plurality of beads on the second link rotate. Also shown in FIGS. 8 and 10, in some embodiments, the link comprises a first link and a second link, the first link and the second link being perpendicular such that the plurality of beads on the first link contact and block the plurality of beads on the second link when the plurality of beads on the second link rotate. In some embodiments, the link further comprises a link body 126. The link body is generally understood as the center of the mass of the link 120. In some embodiments the link body is represented as a cross shaped body with an arm extending from the body. In some embodiments, the plurality of links is all connected as a monolithic piece at its elbow, as shown in FIG. 9.

In many embodiments, the bead product system comprises, consists essentially of, or consists of a plurality of beads, each of the plurality of beads having a first surface 104 facing a first direction opposing a second surface 106 facing a second direction, as shown in FIG. 1. The bead product system a plurality of holding members, one of the plurality of holding members disposed within or attached to the plurality of beads; a framework formed from the holding member and the plurality of beads, the framework having a first configuration and a second configuration; and a locking mechanism, the locking mechanism locks positions of the holding member, the plurality of beads or both on the framework in the first configuration and the locking mechanism unlocks only a predetermined bead of the plurality beads for movement on the framework in the second configuration.

In many embodiments, the bead product system comprises, consists essentially of, or consists of a plurality of beads, each of the plurality of beads having a first axial position; a plurality of holding members axially stationary relative to the plurality of beads, one of the plurality of holding members disposed within or attached to the plurality of beads; a framework formed from the holding member and the plurality of beads; and a locking mechanism, the locking mechanism restricts the axial positions of the plurality of beads, the plurality of beads or both on the framework in the first configuration and the locking mechanism unlocks only a predetermined bead of the plurality beads for movement on the framework to change into the second configuration. A predetermined bead can be any single bead or beads that a user desires to change its or their axial positions.

In many embodiments, the bead product system comprises, consists essentially of, or consists of a plurality of beads, each of the plurality of beads having a first axial position; a plurality of holding members axially stationary relative to the plurality of beads, one of the plurality of holding members disposed within or attached to the plurality of beads; a framework formed from the holding member and the plurality of beads; and a locking mechanism, the locking mechanism restricts the axial positions of the plurality of beads, the plurality of beads or both on the framework in the first configuration and the locking mechanism unlocks only a predetermined bead of the plurality beads for movement on the framework to change into the second configuration.

In many embodiments, the bead product system comprises, consists essentially of, or consists of a bead having a first range of axial positions; a holding member disposed within the bead providing a pivot allowing the bead to rotate; and a second bead adjacent to the bead such that the second bead restricts the first range of axial position of the bead. In some embodiments, the bead product system includes a third bead adjacent to the bead such that the third bead restricts the first range of axial position of the bead. In some embodiments, the bead product system includes a fourth bead adjacent to the bead such that the fourth bead restricts the first range of axial position of the bead. In some embodiments, the bead product system includes more than four beads adjacent to the bead such that the plurality of beads restricts the first range of axial position of the bead.

In one embodiment, the bead product system comprises a plurality of beads, each of the plurality of beads having a first surface facing a first direction opposing a second surface facing a second direction; a plurality of holding members, one of the plurality of holding members disposed within or attached to the plurality of beads; a framework formed from the holding member and the plurality of beads, the framework having a first configuration and a second configuration; and a locking mechanism, the locking mechanism locks positions of the holding member, the plurality of beads or both on the framework in the first configuration and the locking mechanism unlocks only a predetermined bead of the plurality beads for movement on the framework in the second configuration.

In some embodiments, the bead product comprises a plurality of beads, each of the plurality of beads having a first surface facing a first direction opposing a second surface facing a second direction; a plurality of links, one of the plurality of links disposed within the plurality of beads connecting the plurality of beads; a framework formed from the plurality of holding members and the plurality of beads forming a shape and showing a design form by the plurality of beads, the framework is configured to secure the plurality of beads in place such that the plurality of beads cannot move or rotate.

In some embodiments, the bead product system includes a plurality of beads, each of the plurality of beads having a first axial position; a plurality of holding members partially disposed within the plurality of beads providing a pivot allowing each of the plurality of beads to rotate from its first axial position; a framework formed from the holding member and the plurality of beads, the framework having a first configuration and a second configuration; and a locking mechanism, the locking mechanism restricting axial positions of the plurality of holding members, the plurality of beads or both on the framework in the first configuration and the locking mechanism being configured to unlock only a predetermined bead of the plurality beads to change to a second axial position on the framework to reach the second configuration. In some embodiments, in the second configuration, the locking mechanism unlocks only one single bead for movement on the framework. In some embodiments, the framework has a third configuration such that the plurality of beads in the third configuration is facing opposite direction along an axis from the plurality of beads in the first configuration. In some embodiments, the plurality of beads in the second configuration is transverse to the plurality of beads in the first configuration. In some embodiments, the locking mechanism comprises multiple locking points. In some embodiments, in the first configuration, the predetermined bead is locked by one adjacent bead such that the predetermined bead does not rotate into the second configuration. In some embodiments, in the first configuration, the predetermined bead is locked by multiple adjacent beads such that the predetermined bead does not into the second configuration. In some embodiments, at least two holding members are parallel. In some embodiments, at least two holding members are perpendicular. In some embodiments, in the second configuration, the predetermined bead is locked by an adjacent bead such that the predetermined bead does not into the first configuration or third configuration.

In some embodiments, the bead product includes a plurality of beads, each of the plurality of beads having a first surface facing a first direction opposing a second surface facing a second direction; a plurality of links, one of the plurality of links disposed within the plurality of beads connecting the plurality of beads; a framework formed from the plurality of holding members and the plurality of beads forming a shape and showing a first configuration form by the plurality of beads, the framework is configured to lock the plurality of beads in place such that the plurality of beads cannot rotate more than 45 degrees. In some embodiments, one of the plurality of the links is flexible such that the link bends to allow a distance between a bead and an adjacent bead to increase. In some embodiments, the link comprises an elbow providing a pivot configure for the plurality of beads to rotate. In some embodiments, the plurality of the links comprises a first link and a second link, the first link and the second link being parallel such that the plurality of beads on the first link contacts the plurality of beads on the second link. In some embodiments, the plurality of the links comprises a first link and a second link, the first link and the second link being perpendicular such that the plurality of beads on the first link contacts the plurality of beads on the second link. In some embodiments, the plurality of the links is connected to a link body. In some embodiments, the framework is configured to control a predetermined bead of the plurality of beads to rotate.

### Method of Using the Bead Product System

In some embodiments, the bead product system comprises, consists essentially of, or consists of a locking mechanism. The locking mechanism comprises the beads and/or the holding members. In some embodiments, the locking mechanism locks positions of the holding member, the beads or both on the framework in a first configuration or an arrangement of the surface of the beads. In the first configurations, all first surfaces of a bead and its adjacent beads are facing the same direction. In the locked position, the beads are restricted in motion. In some embodiments, the beads are configured rotate axially less than about 90 degrees. In some embodiments, the rotation of the beads is restricted by the adjacent beads as a part of a multi-points lock mechanism. The side surface of a bead is distant from the side surfaces of its adjacent beads in one configuration, for example, when a bead and its adjacent beads have their first surface facing the same direction. When the bead is set to rotate axially and its first surface will turn toward 90 degrees, the side surfaces of the adjacent beads become restrictive members stopping the bead from turning. In some embodiments, a bead is limited by two adjacent beads. In some embodiments, a bead is limited by three adjacent beads. In some embodiments, a bead is limited by four adjacent beads. The arrangement of the beads, holding members, or the framework determines the number of the adjacent beads to a bead. The bead maybe limited by any number of adjacent beads. In some embodiments, a corner bead is limited by the side surface s of two adjacent beads, as shown in FIG. 11. In a second configuration of the locked mechanism, a bead is transverse to its adjacent bead such that the first surface of the bead is facing a different angle from about 1 to about less than 180 degrees from the bead's original axial position. In some embodiments, the second configuration includes the angles from about 1 to 10, 15, 20, 25, 30, 35, 40, 45, 50, 55, 60, 65, 70, 75, 80, 85, 90, 95, 100, 105, 110, 115, 120, 125, 130, 135, 140, 145, 150, 155, 160, 165, 170, 175, to about 180 degrees. It is also understood that the locking mechanism includes restrictive angles which are certain minimum angles that are required to allow the bead to pass the restriction of the side surface of the adjacent beads. A minimum restrictive angle α or range of angles can vary from about 5, 10, 15, 20, 25, 30, 35, 40, 45, 50, 55, 60, 65, 70, 75, 80, 85, to about 90 degrees. The restrictive angles can be controlled by the distance between two beads. In some embodiments, the adjacent beads may be separated manually allowing the minimum angle to decrease and easier passing of the bead to change configurations. In some embodiments, a bead needs to pass a range of restrictive angles to enter from the first configuration to the second configuration. In a third configuration, the first surface of a bead is facing an opposite direction or about 180 degrees from the bead's original axial position. In the third configuration, there is also a restrictive angle β which is a minimum angle or a range of angles that are required to allow the bead to pass the restriction of the side surface of the adjacent beads. A minimum restrictive angle β or range of angles can vary from about 5, 10, 15, 20, 25, 30, 35, 40, 45, 50, 55, 60, 65, 70, 75, 80, 85, to about 90 degrees. In some embodiments, α and β have the same angle or the same range of angles.

In some embodiments, the beads are unlocked from its axial position by passing the restrictive angles formed by the side surface the adjacent beads. In some embodiments, the beads unlocked from its axial position by bending, stretching, moving the holding member such that the distance between beads are wide enough for the beads to rotate without being stopped by another beads. In some embodiments, a bead is locked translationally along a holding member by its adjacent beads. In some embodiments, a bead is locked translationally along a holding member by the structure of the holding member. In some embodiments, the holding member comprises a body with wider perimeter such as a cross as illustrated in FIGS. 4, 5, 8, 9 and 11; and a tubular or cylindrical arm or arms extending form the body of the holding member such that a bead is disposed on the arm. The length of the arm determines the distance a bead can move translationally. In some embodiments, the arm comprises various diameters such that the distance a bead can move is determined by the diameter of the opening of a bead. In some embodiments, the bead is disposed on the elbow of the holding member and there is insignificant or no translational movement allowed by the bead. The elbow of the holding member has various shapes including sphere, semi-sphere, rectangle, cube and other shapes such that the elbow is configured to be received in a recessed area in the bead and facilitate the bead's rotational movement. In some embodiments, a user is given a bead products systems with first surfaces and second surfaces of beads randomly arranged. The user unlocks a desired bead and uses a first force to rotate the bead to a restrictive angle. The user uses a second force to rotate the bead to pass the restrictive angle. The minimum second force is greater than the minimum first force. The user uses a third force to rotate the bead to its final axial position the user desires. The minimum second force is greater than the minimum third force. The user repeats the process until all desires beads are in the user's desire axial positions and arrive at a new arrangement of the bead product system in accordance with the principles of the present disclosure.

In some embodiments, a method of using a bead product system comprises, consists essentially of, or consists of the following features is provided. The method includes using a first force to rotate a bead to a first restrictive angle, using a second force to pass the first restrictive angle, and using a third force to rotate the bead to a final axial position. In some embodiments, the method comprises using a second force to increase the distance between the bead and an adjacent bead. In some embodiments, the method comprises using a locking mechanism to limit an axial rotation of a bead. In some embodiments, in the first configuration, the bead is configured to rotate between about 1 to about 45 degrees before reaching the restrictive angle. It is also understood that in some embodiments, the steps are performed in a specific order.

### Method of Making the Bead Product System

In some embodiments, a method of making a bead product system comprises, consists essentially of, or consists of the following features is provided. In some embodiments, the method includes providing a plurality of beads such as the beads shown on FIGS. 1-10, each of the plurality of beads having a first surface facing a first direction opposing a second surface facing a second direction; providing a plurality of holding members, one of the plurality of holding members disposed within or attached to the plurality of beads; arranging the holding member and the plurality of beads to form a first configuration having a first range of axial positions; and providing a locking mechanism, the locking mechanism setting axial angles for the first range of axial positions of the plurality of holding members, the plurality of beads or both in the first configuration and the locking mechanism being configured to unlock the plurality beads to change axial positions to reach a second range of axial positions. In some embodiments, the angle is set by adjusting the distance or the void between/among beads.

In some embodiments, the method includes securing the plurality of beads onto the plurality of holding members. In another embodiment, the plurality of beads is overmolded onto the holding members. In some embodiments, the holding members are arranged to be in parallel and/or perpendicular such that the beads on the holding members contacting/blocking their adjacent beads. In some embodiments, a securing mechanism includes protrusion 117 and cavity 119 between a first piece of a bead and a second piece of the bead, or vice versa. In some embodiments, the securing mechanism includes a boss and a recessed area with a snap-fit. In some embodiments, the first piece and the second piece of the bead are connected via an adhesive. In some embodiments, the bead is a monolithic piece such that the bead is consisting of one single piece.

In some embodiments, a method of making a bead product system comprises, consists essentially of, or consists of the following features is provided. The method of making a bead product system including: providing a plurality of beads, each of the plurality of beads having a first surface facing a first direction opposing a second surface facing a second direction; providing a plurality of holding members, one of the plurality of holding members disposed within or attached to the plurality of beads; forming a framework from the holding member and the plurality of beads, the framework having a first configuration and a second configuration; and providing a locking mechanism, the locking mechanism locks positions of the holding member, the plurality of beads or both on the framework in the first configuration and the locking mechanism unlocks only a predetermined bead of the plurality beads for movement on the framework in the second configuration. In some embodiments, the method comprises molding a monolithic set of holding members forming a framework and overmolding beads onto the framework to form the bead product system. In some embodiments, the method comprises providing a first piece of a bead; placing a holding member; placing a second piece of a bead over the holding member such that the first piece and the second piece is secured via a securing mechanism to form a complete bead around the holding member. In some embodiments, the holding member forms a frame. The method further comprises forming a plurality of modules into a framework to form a bead product system. In some embodiments, the method comprises forming a framework from a holding member; placing a first piece of a bead onto the holding member; securing a second piece of the bead to the first piece of the bead.

In some embodiments, the method includes providing a plurality of beads, each of the plurality of beads having a first surface facing a first direction opposing a second surface facing a second direction; providing a plurality of holding members, one of the plurality of holding members disposed within or attached to the plurality of beads; forming a framework from the holding member and the plurality of beads, the framework having a first configuration and a second configuration transverse to each other; and providing a locking mechanism, the locking mechanism restricting axial positions of the plurality of holding members, the plurality of beads or both on the framework in the first configuration and the locking mechanism being configured to unlock only a predetermined bead of the plurality beads to change to a second axial position on the framework to reach the second configuration. In some embodiments, the method comprises securing the plurality of beads onto the plurality of holding members. In some embodiments, the locking mechanism comprises multiple locking points.

In some embodiments, the method comprises providing a plurality of beads, each of the plurality of beads having a first surface facing a first direction opposing a second surface facing a second direction; providing a plurality of holding members, one of the plurality of holding members disposed within or attached to the plurality of beads; arranging the holding member and the plurality of beads to form a first configuration having a first range of axial positions; and providing a locking mechanism, the locking mechanism setting axial angles for the first range of axial positions of the plurality of holding members, the plurality of beads or both in the first configuration and the locking mechanism being configured to unlock the plurality beads to change axial positions to reach a second range of axial positions.

It will be understood that various modifications may be made to the embodiments disclosed herein. Therefore, the above description should not be construed as limiting, but merely as exemplification of the various embodiments. Those skilled in the art will envision other modifications within the scope and spirit of the claims appended hereto.

What is claimed is:

1. A bead product system comprising:
a plurality of beads, each of the plurality of beads comprising a configuration, the configuration having a first range of axial positions in a first configuration, having a second range of axial positions in a second configuration and having a third range of axial positions in a third configuration;
a plurality of holding members partially disposed within the plurality of beads having a pivot allowing each of the plurality of beads to rotate; and
a locking mechanism configured to lock the plurality of the plurality of beads in the first range of axial positions and to unlock only a first bead of the plurality of beads allowing the first bead to rotate to the second range of axial positions, and the locking mechanism also configured to lock the plurality of the plurality of beads in the second range of axial positions, the locking mechanism comprising a second bead of the plurality of beads adjacent to the first bead preventing the first bead to rotate from the first configuration to the second configuration.

2. The system in claim 1, wherein the locking mechanism unlocks only one single bead of the plurality of beads to rotate.

3. The system in claim 1, wherein the plurality of beads in the third configuration is facing opposite direction along an axis from the plurality of beads in the first configuration.

4. The system in claim 1, wherein the plurality of beads in the second configuration is configured to be transverse to the plurality of beads in the first configuration.

5. The system in claim 1, wherein the second bead comprises a perimeter or an edge contacting and/or blocking the first bead from rotating into the second configuration.

6. The system in claim 1, wherein the locking mechanism comprises multiple locking points.

7. The system in claim 1, wherein the first bead in the first range of axial positions is locked by a third bead adjacent to the first bead such that the first bead does not rotate into the second configuration.

8. The system in claim 1, wherein the locking mechanism having at least two holding members of the plurality of holding members being parallel.

9. The system in claim 1, wherein the locking mechanism having at least two holding members of the plurality of holding members being perpendicular.

10. The system in claim 1, wherein each of the plurality of holding members comprises an arm and an elbow.

11. A bead product comprising:
a plurality of beads comprising a first bead having a first axial position and a second bead having an edge adjacent to the first bead;
a link disposed within the plurality of beads connecting the plurality of beads, the link comprising an arm and an elbow such that the first bead configured to be rotated on a pivot formed by the elbow; and
a locking mechanism formed by the edge of the second bead locking the first bead such that the first bead cannot rotate more than 45 degrees.

12. The product in claim 11, wherein the links is flexible such that the link is configured to increase a distance between the first bead and the second bead.

13. The product in claim 11, wherein the plurality of beads comprises a third bead having a second edge and forming the locking mechanism to the second bead.

14. The product in claim 11, wherein the link comprises a first link and a second link, the first link and the second link being parallel such that the plurality of beads on the first link contact and the block the plurality of beads on the second link when the plurality of beads on the second link rotate.

15. The product in claim 11, wherein the link comprises a first link and a second link, the first link and the second link being perpendicular such that the plurality of beads on the first link contact and block the plurality of beads on the second link when the plurality of beads on the second link rotate.

16. The product in claim 11, wherein the link further comprises a link body.

17. The product in claim 11, wherein the link is a monolithic piece.

18. A method of making a bead product system comprising:
providing a plurality of beads, each of the plurality of beads having a first surface facing a first direction opposing a second surface facing a second direction;
providing a plurality of holding members, one of the plurality of holding members disposed within or attached to the plurality of beads;
arranging the holding member and the plurality of beads to form a first configuration having a first range of axial positions; and
providing a locking mechanism, the locking mechanism setting axial angles for the first range of axial positions of the plurality of holding members, the plurality of beads or both in the first configuration and the locking mechanism being configured to unlock the plurality beads to change axial positions to reach a second range of axial positions.

19. The method in claim 18, wherein the method comprise securing the plurality of beads onto the plurality of holding members.

20. The method in claim 18, wherein the locking mechanism comprises multiple locking points.
